(19) United States
(12) Patent Application Publication
(10) Pub. No.: US 2023/0371556 A1
(43) Pub. Date: Nov. 23, 2023

(54) PURIFICATION METHOD WITH RECYCLING OF EFFLUENTS

(71) Applicant: NOVASEP PROCESS SOLUTIONS, Saint-Maurice-de-Beynost (FR)

(72) Inventors: Annick MERRIEN, Saint-Maurice-de-Beynost (FR); François ROUSSET, Saint-Maurice-de-Beynost (FR)

(21) Appl. No.: 18/028,197

(22) PCT Filed: Sep. 24, 2021
(86) PCT No.: PCT/FR2021/051644

§ 371 Date: Mar. 23, 2023

(30) Foreign Application Priority Data
Sep. 24, 2020 (FR) FR2009748

(51) Int. Cl. A23L 2/78; A23L 2/04; B01J 39/20; B01J 41/14; B01J 49/57; B01J 49/53

(52) U.S. Cl. CPC A23L 2/78; A23L 2/04; B01J 39/20; B01J 41/14; B01J 49/57; B01J 49/53

(57) ABSTRACT

The invention relates to a purification method, comprising the following steps: —supplying a stream (6) comprising a non-ionised species, monovalent cations and divalent cations; bringing the stream (6) into contact with a first cation exchange resin (1) in sodium and/or potassium form; —collecting a first fraction (7) which contains the non-ionised species and is enriched in monovalent cations and depleted of divalent cations with respect to the stream (6); —bringing the first fraction (7) into contact with a second cation exchange resin (2) in hydronium form; —collecting a second fraction (8) which contains the non-ionised species and is depleted of monovalent cations with respect to the first fraction (7); —regenerating the second cation exchange resin (2) with a sulphuric acid solution (10); —collecting a first regeneration effluent comprising at least one fraction A, the fraction A comprising sodium and/or potassium ions; and —recycling the fraction A to regenerate the first cation exchange resin (1).

### FIELD OF THE INVENTION

The present invention relates to a method for purifying a non-ionised species, comprising recycling of effluents.

### TECHNICAL BACKGROUND

In the food industry, numerous liquid products, juices in particular, must undergo purification, and more particularly demineralisation to remove divalent and monovalent ions contained therein.

Conventionally, demineralization of juices is performed in batch mode on a line comprising a single column containing a cation exchange resin (or cationic resin) in H⁺ form, in series with a single column containing an anion exchange resin (or anionic resin). Typically, demineralisation of juices is conducted on two lines operating in parallel, the juice to be treated being alternately loaded onto each of the lines. Therefore, while the product to be treated is loaded onto a column of the first line, the corresponding column of the second line is washed, regenerated and then rinsed for treatment of the next load of product.

In these processes, the cationic resin and anionic resin are conventionally regenerated with a sulphuric acid solution and ammonia solution respectively, so that the regeneration effluents of the two resins can be upgraded through the production of ammonium sulphates able to be used as fertiliser.

However, the juices to be treated often comprise divalent ions such as calcium ions. These calcium ions may form complexes with anions such as the sulphate ions brought in particular during regeneration of the cationic resin with sulphuric acid, resulting in the precipitation of calcium sulphate. To prevent this precipitation, regeneration of the cationic resin is performed in several successive steps with sulphuric acid solutions having increasing concentrations of sulphuric acid. Therefore, the cationic resin is generally first regenerated by passing a 2 weight % sulphuric acid solution, followed by a 5 weight % sulphuric acid solution and finally a 10 weight % sulphuric acid solution.

However, the use of several sulphuric acid solutions of increasing concentration to regenerate the cation exchange resin leads to high consumption of regenerating solution. Additionally, said regeneration can be difficult to implement in a continuous purification process.

Document EP1540019 B1 describes a method for purifying an aqueous solution containing sugars, cations and anions, comprising treatment of the aqueous solution with a cationic resin and with an anionic resin, nanofiltration of the solution obtained and demineralization of the nanofiltration retentate with a cation exchange resin and an anion exchange resin. The cation and anion exchange resins are then respectively regenerated with hydrochloric acid and sodium hydroxide, and the cationic and anionic resins of the first step can be regenerated with the nanofiltration permeate. This purification method requires a nanofiltration step and may comprise a reverse osmosis step. Yet, the regenerants of these membrane systems comprise complex products that are non-recyclable and non-upgradable, thereby generating substantial non-upgradable regeneration effluents. Also, the membranes have a limited lifetime leading to high operating costs. Additionally, in this method the regeneration effluents of the ion exchange resins, and particularly of the cationic and anionic resins of the first step, are not upgraded and demineralization is not continuous.

There is therefore a true need to provide a purification method allowing regeneration of resins that consumes fewer chemical products, whilst permitting upgrading of regeneration effluents and able to be implemented at least in part in continuous mode.

### SUMMARY OF THE INVENTION

The invention first relates to a purification method comprising the following steps:
supplying a stream comprising a non-ionised species, monovalent cations and divalent cations;
bringing the stream into contact with a first cation exchange resin in sodium and/or potassium form;
collecting a first fraction containing the non-ionised species, enriched in monovalent cations and depleted of divalent cations with respect to the stream;
bringing the first fraction into contact with a second cation exchange resin in hydronium form;
collecting a second fraction containing the non-ionised species and depleted of monovalent cations with respect to the first fraction;
regenerating the second cation exchange resin with a sulphuric acid solution;
collecting a first regeneration effluent comprising at least one fraction A, said fraction A comprising sodium and/or potassium ions;
recycling fraction A to regenerate the first cation exchange resin.

In some embodiments, the stream also comprises anions, said method further comprising the following steps:
bringing the second fraction into contact with an anion exchange resin;
collecting a third fraction containing the non-ionised species and depleted of anions with respect to the second fraction;
regenerating the anion exchange resin with a solution comprising a hydroxide salt, preferably potassium hydroxide and/or ammonium hydroxide;
collecting a second regeneration effluent.

In some embodiments, the first regeneration effluent also comprises a fraction B, fraction B having a lower concentration of sodium and/or potassium ions than fraction A of the first effluent, said method further comprising:
mixing at least part, preferably the entirety, of the second effluent with all or part of fraction B of the first effluent, to obtain a mixture of effluents comprising at least one sulphate salt, preferably ammonium sulphate and/or potassium sulphate;
evaporating at least part, preferably the entirety, of the mixture of effluents, to obtain a concentrated fraction comprising the at least one sulphate salt; and
optionally, a crystallization step of at least part, preferably the entirety, of the concentrated fraction, to obtain a crystallized fraction comprising the at least one sulphate salt.

In some embodiments, the method comprises collecting a third regeneration effluent from the first cation exchange resin, and at least part and preferably the entirety of the second effluent is mixed with all or part of fraction B of the first effluent and with at least part and preferably the entirety of the third effluent, to obtain the mixture of effluents comprising at least one sulphate salt, preferably ammonium sulphate and/or potassium sulphate.

In some embodiments, the first regeneration effluent also comprises a fraction B, fraction B having a lower concentration of sodium and/or potassium ions than fraction A of the first effluent, said method further comprising a step of recycling at least part of fraction B to regenerate the second cation exchange resin.

In some embodiments, the method further comprises a step of recycling at least part of the second regeneration effluent to regenerate the anion exchange resin.

In some embodiments, the step of bringing the first fraction into contact with the second cation exchange resin is conducted in a multicolumn ion exchange installation, the installation preferably comprising 4 to 25 columns.

In some embodiments, the step of bringing the second fraction into contact with the anion exchange resin is conducted in a multicolumn ion exchange installation, the installation preferably comprising 4 to 25 columns.

In some embodiments, fraction A represents at most 70% by volume of the first regeneration effluent.

In some embodiments, the sulphuric acid solution has a constant concentration of sulphuric acid, the sulphuric acid solution preferably comprising 1 to 10% by weight of sulphuric acid, more preferably 3 to 9% by weight of sulphuric acid.

In some embodiments, the non-ionised species is selected from the group consisting of polysaccharides such as inulin, oligosaccharides such as fructo-oligosaccharides, monosaccharides, disaccharides such as sucrose, and combinations thereof.

In some embodiments, the step of bringing the first fraction into contact with the second cation exchange resin and/or the regeneration of the second cation exchange resin is conducted continuously.

In some embodiments, the step of bringing the second fraction into contact with the anion exchange resin and/or the regeneration of the anion exchange resin is carried out continuously.

In some embodiments the first cation exchange resin and the second cation exchange resin have identical matrices.

In some embodiments, the first regeneration effluent consists of fraction A and fraction B.

In some embodiments, the stream has a dry matter content of 5 to 50% by weight, preferably 10 to 20% by weight.

In some embodiments, the divalent cations comprise calcium ions, preferably contained the stream in a concentration of 10 to 1000 mg/L, preferably 100 to 500 mg/L, and/or magnesium ions preferably contained in the stream in a concentration of 5 to 500 mg/L, preferably 5 to 100 mg/L, and/or the monovalent cations comprise sodium ions and/or potassium ions.

In some embodiments, the anions comprise chloride ions and/or sulphate ions and/or phosphate ions.

The present invention allows the above-expressed need to be met. It more particularly provides an improved method for purifying a non-ionised species whereby the consumption of regenerants is reduced. In addition, the method of the invention may allow regeneration effluents to be minimised via upgrading and/or full reuse thereof.

This is achieved through the use of two cationic resins in different ionic form and through the use of part of the regeneration effluents of one of the cationic resins to regenerate the other cationic resin. Indeed, the use of a first cationic resin in sodium and/or potassium form allows the removal from the stream to be treated of divalent cations such as calcium ions. The divalent ions, and calcium ions in particular, having been removed at least in part from the fraction passing through the second cation exchange resin, this latter resin can be regenerated with a single sulphuric acid solution of relatively high concentration, without the risk (or with only a very limited risk) of precipitation of the calcium ions, in the form of calcium sulphate in particular. This makes it possible to reduce the amount of sulphuric acid solution used for regeneration.

In addition, part of the regeneration effluents of the second cationic resin is used to regenerate the first cationic resin, which also affords a reduction in regenerant consumption as well as a reduction in regeneration effluents.

Also, the non-reused regeneration effluents of the different ion exchange resins used in the method of the invention can be upgraded in full or in part, by producing a concentrated or crystallized fraction of sulphate salts, these sulphate salts being then able to be reused, for example to manufacture fertilisers. Additionally, in the embodiments in which the starting stream to be treated comprises organic acids, the crystallization of these regeneration effluents can also result in obtaining a fraction comprising these organic acids, this fraction being then able to be used to produce animal feed. Alternatively, or in addition, these regeneration effluents can be reused to regenerate the resins from which they are derived.

Finally, the demineralization of the method of the invention can be conducted continuously, which has the following advantages compared with demineralization performed in batch mode: a lesser quantity of chemical products is used for regeneration of the ion exchange resins, the production of regeneration effluents is smaller, the total volume of resin used can be further reduced and the use of buffer tanks can be avoided.

### BRIEF DESCRIPTION OF THE FIGURES

FIG. 1 is a block diagram of one embodiment of the method of the invention. The solid line arrows correspond to the streams/fractions engaged at the loading and purification steps on the resins, and the dotted line arrows represent the streams/fractions engaged at the regeneration steps of the resins.

FIG. 2 is a block diagram of another embodiment of the method of the invention. The solid line arrows correspond to the streams/fractions engaged at the loading and purification steps on the resins, and the dotted line arrows represent the streams/fractions engaged at the regeneration steps of the resins.

### DETAILED DESCRIPTION

A more detailed, nonlimiting description of the invention is given below.

Unless otherwise stated, all percentages concerning quantities are weight percentages.

The invention concerns the purification of a non-ionised species contained in a stream, to remove monovalent and divalent cations and optionally anions. Herein, this stream is also called “stream to be treated” or “input stream”.

The species to be purified can be any non-ionised species. It can particularly be selected from among the group formed by polysaccharides, oligosaccharides, disaccharides and monosaccharides.

As polysaccharides, mention can be made for example of inulin, starch hydrolysates, cellulose hydrolysates and/or inulin hydrolysates, inulin being preferred.

As oligosaccharides, mention can be made for example of fructo-oligosaccharides, galacto-oligosaccharides, xylo-oligosaccharides, raffinose, stachyose, fucosyllactose and/or panose, fructo-oligosaccharides being preferred.

As disaccharides, mention can be made for example of sucrose, lactose, lactulose, maltose, maltulose and/or trehalose, sucrose being preferred.

As monosaccharides, mention can be made for example of glucose, fructose, xylose, mannose, psicose and/or tagatose.

It is also possible to use a combination of two or more of the above-mentioned species.

The stream to be treated comprises divalent cations. More particularly, it may comprise calcium ions (Ca²⁺) and/or magnesium ions (Mg²⁺). In some embodiments, the divalent cations consist of Ca²⁺ ions and/or Mg²⁺ ions.

In particular, the stream to be treated preferably comprises from 10 to 1000 mg/L, more preferably 100 to 500 mg/L of calcium ions. The stream may comprise from 10 to 50 mg/L, or 50 to 100 mg/mL, or 100 to 200 mg/mL, or 200 to 300 mg/mL, or 300 to 400 mg/mL, or 400 to 500 mg/mL, or 500 to 600 mg/mL, or 600 to 700 mg/mL, or 700 to 800 mg/mL, or 800 to 900 mg/mL, or 900 to 1000 mg/mL of calcium ions. The concentration of Ca²⁺ ions can be determined following standard ICUMSA GS7-19.

In particular, the stream to be treated preferably comprises from 5 to 500 mg/L, more preferably 5 to 100 mg/L of magnesium ions. The stream may comprise from 5 to 20 mg/mL, or 20 to 50 mg/mL, or 50 to 100 mg/mL, or 100 to 200 mg/mL, or 200 to 300 mg/mL, or 300 to 400 mg/mL, or 400 to 500 mg/mL of magnesium ions. The concentration of Mg²⁺ ions can be determined following standard ICUMSA GS7-19.

The stream to be treated also comprises monovalent cations. Preferably, the stream comprises sodium ions (Na⁺) and/or potassium ions (K⁺). In some embodiments, the monovalent cations consist of Na⁺ and/or K⁺ ions.

The stream to be treated may also comprise anions. For example, the stream may comprise chloride ions (Cl⁻), sulphate ions (SO₄²⁻) and/or phosphate ions (PO₄³⁻). In some embodiments, the anions consist of Cl⁻ and/or SO₄²⁻ and/or PO₄³⁻ ions.

In some embodiments, the stream to be treated comprises Ca²⁺, Mg²⁺, Na⁺, K⁺, Cl⁻, SO₄²⁻ and/or PO₄³⁻ ions.

The stream to be treated may also comprise organic acids, proteins and/or dyes.

Advantageously, the dry matter content of the input stream is 5 to 50% by weight, preferably 10 to 20% by weight. In particular, the stream to be treated may have a dry matter content of 5 to 10%, or 10 to 15%, or 15 to 20%, or 20 to 25%, or 25 to 30%; or 30 to 35%, or 35 to 40%, or 40 to 45% or 45 to 50% by weight. The dry matter content can be determined following standard ICUMSA GS7-31.

The input stream can be a juice, i.e. a liquid extracted from at least one fruit, vegetable or plant.

The input stream may have previously been subjected to one or more pre-treatment steps, such as one or more centrifugations, filtrations, carbonatation, floatation and/clarification.

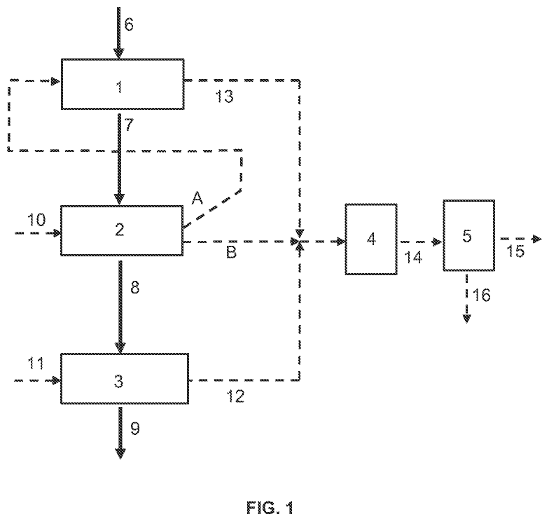

With reference to FIG. 1, the input stream 6 is brought into contact with a first cation exchange resin 1. This first cation exchange resin is in sodium and/or potassium form, i.e. the counter-ion of the negative charge groups of the resin, before passing of the stream to be treated, is the Na⁺ ion and/or K⁺ ion.

Preferably, the first cation exchange resin 1 is a strong cationic resin.

The resin used may comprise an acrylic or styrene matrix. It may in particular comprise or consist of a polystyrene-divinylbenzene copolymer. Examples of resins able to be used in the method of the invention as first cation exchange resin are the resins Applexion® XA2041 Na, Applexion® XA2043 Na and Applexion® XA2044 Na.

This contacting step can be conducted in an ion exchange installation comprising a single column containing the first cation exchange resin. Alternatively, the ion exchange installation to implement this step may comprise several columns used in series or in parallel, containing a cation exchange resin, preferably the same resin in all the columns of this installation.

This ion exchange installation can have a static bed or non-static bed.

The contacting of the stream to be treated 6 with the first cation exchange resin 1 will allow the divalent cations contained in the stream to be adsorbed on the resin by displacing the counter-ions of the resin. The counter-ions displaced from the resin by the divalent cations (i.e. the Na⁺ and/or K⁺ ions) will be found in the fraction collected at the outlet of the resin. The non-ionised species will not or will only scarcely be retained by the cation exchange resin and will also be found in the fraction collected at the outlet of the resin.

Therefore, after the contacting of the input stream with the first cation exchange resin, a first fraction 7 leaving the resin is collected. This fraction is enriched in monovalent cations and depleted of divalent cations with respect to the input stream 6. By “fraction enriched in monovalent cations and depleted of divalent cations with respect to the input stream” it is meant a fraction in which the molar concentration ratio of monovalent cations/divalent cations is higher than that of the input stream. In particular, this first fraction 7 comprises Na⁺ and/or K⁺ ions derived from the first cationic resin. The first fraction 7 also comprises the non-ionised species to be purified.

After being brought into contact with the input stream, the first cation exchange resin 1 comprises divalent cations (initially contained in the stream to be treated) as counter-ions. The first cation exchange resin then undergoes regeneration. By “resin regeneration” it is meant washing of the resin with a specific wash solution called regeneration solution or regenerant, intended to recondition the resin into a particular ionic form able to allow efficient ion exchange separation. The stream of liquid obtained at the outlet of the resin after regeneration is called the “regeneration effluent”.

Regeneration of the first cation exchange resin is intended to place the resin in sodium and/or potassium form, i.e. to replace the counter-ions of the resins by Na⁺ or K⁺ cations.

The first cation exchange resin 1 is regenerated by passing one or more regeneration solutions comprising Na⁺ or K⁺ ions through the resin. Preferably, the regeneration solution(s) contain sodium sulphate and/or potassium sulphate.

Advantageously, the sodium sulphate and/or potassium sulphate is contained in the regeneration solution(s) in an amount ranging from 1 to 10% by weight, more preferably 2 to 10% by weight, further preferably 3 to 9% by weight, for example in an amount of about 5% by weight. In some embodiments, the sodium sulphate and/or potassium sulphate is contained in the regeneration solution(s) in an amount ranging from 1 to 3% or 3 to 5%, or 5 to 7% or 7 to 10% by weight. The concentration of sulphate salts in the regeneration solution is such that the calcium sulphate does not or only scarcely precipitates in the column of the first cation exchange resin at this regeneration step.

The regeneration solution(s) are derived fully or partly from subsequent purification steps, and in particular from the regeneration steps via recycling as described below. The regeneration solution(s) are passed through the resin in the same direction as the stream to be treated, or in the opposite direction to the stream to be treated.

The regeneration effluent 13 of the first cation exchange resin called herein “third regeneration effluent” particularly contains the divalent cations such as Ca²⁺ and/or Mg²⁺ ions which were adsorbed on the first cation exchange resin when it was brought into contact with the stream to be treated. This effluent 13 also contains at least some monovalent cations such as Na⁺ and/or K⁺ cations, and preferably sulphate ions derived in particular from the regeneration solution.

The first fraction 7 enriched in monovalent cations and depleted of divalent cations with respect to the stream 6, collected after treatment of the input stream by the first cation exchange resin, is subjected to treatment by a second cation exchange resin 2.

The second cation exchange resin 2 is in hydronium form (H⁺), i.e. the counter-ion of the negative charge groups of the resin, before passing of the fraction to be treated, is the H⁺ ion.

Advantageously, the second cation exchange resin 2 is a strong cationic resin.

The second cation exchange resin 2 may comprise an acrylic or styrene matrix. In particular, it may comprise or consist of a polystyrene-divinylbenzene copolymer. Examples of resins able to be used in the method of the invention as second cation exchange resin are the resins Applexion® XA2041, Applexion® XA 2043 and Applexion® XA2044. Preferably, the first and second cation exchange resins used in the method of the invention are the same (with the exception of their ionic form, i.e. of their counter-ions). In other words, the first and second cation exchange resins can have the same matrix. Herein, by “resin matrix” it is designated the ion exchange resin without the counter-ions adsorbed on the charged groups of the resin. Alternatively, the matrixes of the cation exchange resins can be different.

The fraction to be treated 7 is brought into contact with the second cation exchange resin 2 in an ion exchange installation which may comprise one or more columns. In particularly preferred manner, the ion exchange installation comprises 4 to 25 ion exchange columns comprising the second cation exchange resin, more preferably 6 to 20 columns. Preferably, all the columns of this ion exchange installation have the same resin.

The columns of the ion exchange installation can all be connected in series or all connected in parallel, or the installation may comprise some columns connected in series and some columns connected in parallel. The connecting of the columns together (in series or in parallel) may vary over time, in particular depending on the step being performed on said columns.

When the first fraction 7 (enriched in monovalent cations and depleted of divalent cations with respect to the stream) is brought into contact with the second cation exchange resin 2, the monovalent cations and particularly the Na⁺ and/or K⁺ ions are adsorbed on the resin. The non-ionised species is not or only scarcely retained by the cation exchange resin and can be collected at the outlet of the resin. A second fraction 8 is thereby obtained, containing the non-ionised species and depleted of monovalent cations with respect to the first fraction 7 (i.e. the molar concentration ratio of non-ionised species/monovalent cations is higher than that of the first fraction), on the understanding that by monovalent cations here it is meant monovalent cations other than the H⁺ ion.

More preferably, when the input stream 6 comprises at least one protein, the second fraction 8 is depleted of the at least one protein with respect to the first fraction 7 (i.e. the molar concentration ratio of non-ionised species/proteins is higher than that of the first fraction). When the input stream 6 comprises at least one dye, the second fraction 8 can be depleted of the at least one dye with respect to the first fraction 7 (the molar concentration ratio of non-ionised species/dyes being higher than that of the first fraction).

The yield of non-ionised species resulting from the above described separations, corresponding to the molar percentage of non-ionised species in the input stream which is recovered in the second fraction, is advantageously 90% or higher, preferably 95% or higher, more preferably 97% or higher, further preferably 98% or higher, still further preferably 99% or higher, most preferably 99.5% or higher.

Regeneration of the second cation exchange resin 2 is performed to convert the resin to H⁺ form. For this purpose, one or more regeneration solutions 10 are brought into contact with the resin to be regenerated. According to the invention, at least one regeneration solution 10 (and preferably all thereof when several regeneration solutions are used) is a sulphuric acid solution, preferably an aqueous sulphuric acid solution, more preferably a solution of sulphuric acid in water. Advantageously, the sulphuric acid solution(s) are passed through the resin in the same direction as the fraction to be treated.

In particularly preferred manner, a single sulphuric acid solution is used to regenerate the second cation exchange resin, i.e. a single regeneration solution with a constant concentration of sulphuric acid is used. This has the advantage of reducing the quantities of regeneration solution used.

The sulphuric acid solution (or one or all of the sulphuric acid solutions) preferably has a sulphuric acid content (or concentration) of 1 to 10% by weight, more preferably 2 to 10% by weight, further preferably 3 to 9% by weight, for example a content of about 5% by weight. In some embodiments, the sulphuric acid solution comprises from 1 to 3%, or 3 to 5%, or 5 to 7% or 7 to 10% by weight of sulphuric acid. By the sulphuric acid content or concentration of the regeneration solution, it is meant the initial content or concentration of the regeneration solution before it is brought into contact with the resin.

It is possible to use one or more fresh sulphuric acid solutions as regeneration solutions throughout the implementation of the method, or else it is possible to use one or more fresh sulphuric acid solutions as initial regeneration solutions, the following sulphuric acid regeneration solutions being derived from the regeneration effluents of the second cation exchange resin, as described below.

After this regeneration step, a regeneration effluent called “first regeneration effluent” is collected. This first effluent may comprise at least a fraction A and a fraction B, in the order in which the effluent leaves the resin. Fraction A therefore corresponds to a fraction collected at the start of regeneration, while fraction B is collected thereafter.

When the second cation exchange resin 2 is brought into contact with the sulphuric acid regeneration solution, in a first phase the H⁺ ions of the regeneration solution will exchange with the monovalent cations adsorbed on the resin, which will therefore be found in the regeneration effluent. These monovalent cations comprise a high proportion of Na⁺ and/or K⁺ ions derived from the counter-ions of the first cation exchange resin and/or initially contained in the stream to be treated. In this first phase, the regeneration effluent comprises a low proportion of H⁺ ions, which are adsorbed on the resin. As regeneration progresses, the proportion of Na⁺ and/or K⁺ ions will decrease and that of the H⁺ ions will increase.

Fraction A has a higher concentration of sodium and/or potassium ions than fraction B. Preferably, fraction A has a lower concentration of H⁺ ions than fraction B.

Fraction A also comprises sulphate ions, derived in particular from the sulphuric acid regeneration solution. Therefore, fraction A comprises sodium sulphate and/or potassium sulphate.

In the method of the invention, fraction A is used as regeneration solution for the first cation exchange resin 1. Fraction A can be used in addition to another or to other regeneration solutions comprising Na⁺ and/or K⁺ ions, such as an aqueous solution of sodium sulphate and/or potassium sulphate (for example, fraction A can be used before or after another regeneration solution, or it can be mixed with another regeneration solution before it is passed through the resin). In some advantageous embodiments, fraction A is the only regeneration solution used to regenerate the first cation exchange resin. Fraction A can be used as such, or it can be concentrated or diluted before use to regenerate the first cation exchange resin, for example so that the content of sodium sulphate and/or potassium sulphate is 1 to 10% by weight, preferably 2 to 10% by weight, more preferably 3 to 9% by weight, for example about 5% by weight.

In some embodiments, fraction A represents at least 50% by volume of the first regeneration effluent, preferably at least 55% by volume, further preferably at least 60% by volume.

Alternatively (or in addition), fraction A can represent at most 70% by volume of the first regeneration effluent, preferably at most 60% by volume, further preferably at most 50% by volume.

The proportion of first regeneration effluent belonging to fraction A (and to the other fractions) can be determined in manner known to those skilled in the art, for example by plotting concentration profiles (e.g. of K⁺, Na⁺ and H⁺ ions) in the regeneration effluent as a function of regeneration time or of the collected volume of regeneration effluent.

Fraction B comprises sulphuric acid H₂SO₄ derived from the regeneration solution, and preferably one or more monovalent cations, in particular cations adsorbed on the resin before regeneration (i.e. initially contained in the stream to be treated and/or derived from the counter-ions of the first cation exchange resin), more preferably Na⁺ and/or K⁺ ions.

The contacting step of the first fraction 7 with the second cation exchange resin 2 (also called “loading of the second cation exchange resin”) and the regeneration step of the second cation exchange resin 2 can each be independently conducted continuously. By “step conducted continuously” it is meant that the step is conducted without interruption throughout the implementation of the method. Preferably, each of these steps (loading and regeneration) is conducted continuously. In these embodiments, these steps are conducted at least partially simultaneously, each one on a column (or on an assembly of several columns in series) connected in parallel or in series with the other column (or assembly of columns) on which the other step is carried out. Preferably, the fluid inlet points and fluid outlet points of each column in the ion exchange installation are periodically shifted, typically by one column, and preferably simultaneously, after completion of each step.

An example of an ion exchange installation for the second cation exchange resin 2 comprises 12 ion exchange columns all comprising a bed of identical cation exchange resin.

Less preferably, the loading and regeneration steps of the second cation exchange resin 2 can be conducted in batch mode, i.e. they are conducted solely in succession, when the preceding step is completed.

Advantageously, the second fraction 8 containing the non-ionised species and depleted of monovalent cations with respect to the first fraction, collected after treatment of the first fraction 7 by the second cation exchange resin 2, can then be brought into contact with an anion exchange resin 3, in particular when the input stream comprises anions.

The anion exchange resin 3 is preferably a weak anionic resin. More preferably, it comprises amine groups. Advantageously, the active groups of the resin (i.e. the anion exchange groups) such as the amine groups, are in ionised form only in an acid medium. The second fraction to be treated 8 is acid on account of the exchange of cations with the H⁺ ions which took place during the treatment step by the second cation exchange resin. When the second fraction 8 is brought into contact with the anionic resin 3, the active groups of the anion exchange resin become ionised under the effect of the acidity of the second fraction, and the anions contained in the second fraction are adsorbed on the ionised groups of the resin. The non-ionised species is not or only scarcely retained by the anion exchange resin and can be collected at the outlet of the resin. A third fraction 9 is then obtained, containing the non-ionised species and depleted of anions with respect to the second fraction 8 (i.e. the molar concentration ratio of non-ionised species/anions is higher than that of the second fraction). More preferably, when the input stream 6 comprises organic acids, the third fraction 9 is depleted of organic acids with respect to the second fraction 8 (i.e. the molar concentration ratio of non-ionised species/organic acids is higher than that of the second fraction). Further preferably, when the input stream 6 comprises dyes, the third fraction 9 is depleted of dyes with respect to the second fraction 8 (i.e. the molar concentration ratio of non-ionised species/dyes is higher than that of the second fraction). Treatment with the second cation exchange resin 2 and treatment with the anion exchange resin 3 allow demineralization of the fractions to be treated.

The anion exchange resin 3 may comprise an acrylic or styrene matrix. In particular, it may comprise or consist of a polystyrene-divinylbenzene copolymer. Examples of resins able to be used in the method of the invention as anion exchange resin are the resins Applexion® XA3041, Applexion® XA3053 and Applexion® XA3063.

The fraction to be treated 8 is brought into contact with the anion exchange resin 3 in an ion exchange installation which may comprise one or more columns. In particularly preferred manner, the ion exchange installation comprises 4 to 25 ion exchange columns comprising the anion exchange resin, more preferably 6 to 20 columns. Preferably, all the columns of this ion exchange installation have the same resin. The columns of this ion exchange installation can all be connected in series, or else all connected in parallel, or the installation may comprise some columns connected in series and some columns connected in parallel. The connecting of the columns together (in series or in parallel) may vary over time, in particular depending on the step being conducted on said columns.

Preferably, the method of the invention comprises regeneration of the anion exchange resin 3. This step is performed using one or more regeneration solutions 11.

Preferably, the regeneration solution 11 (or if several regeneration solutions are used, at least one or preferably all the regeneration solutions) are a basic solution, more preferably a solution that is preferably aqueous comprising a hydroxide salt, and further particularly a solution that is preferably aqueous comprising potassium hydroxide and/or ammonium hydroxide. Still further preferably, the regeneration solution(s) 11 are solutions of potassium hydroxide (KOH) and/or ammonium hydroxide (NH₄OH) in water.

Advantageously, the regeneration solution has an initial content of potassium hydroxide and/or ammonium hydroxide of 2 to 10% by weight, preferably 4 to 6% by weight. In particular the content of potassium hydroxide and/or ammonium hydroxide can be from 2 to 4%, or 4 to 6%, or 6 to 8% or 8 to 10% by weight.

It is possible to use one or more fresh basic solutions as regeneration solutions throughout implementation of the method of the invention, or else it is possible to use one or more fresh basic solutions as initial regeneration solutions, the following basic regeneration solutions being derived from the regeneration effluents of the anion exchange resin, as described below.

Advantageously, the regeneration solution(s) pass through the resin in the same direction as the fraction to be treated.

On leaving the resin, a regeneration effluent 12 is collected called “second regeneration effluent” herein. This second regeneration effluent particularly comprises anions such as the Cl⁻, SO₄²⁻ and/or PO₄³⁻ ions which were adsorbed on the anion exchange resin when it was brought into contact with the fraction to be treated.

The second regeneration effluent 12 may comprise a sulphate salt formed by the association of the SO₄²⁻ anion, derived for example from the anions initially contained in the stream to be treated, with a cation, preferably NH₄⁺ and/or K⁺, derived in particular from the regeneration solution.

Preferably, all or part (preferably all) of the second effluent 12 is mixed (or combined) with all or part (preferably all) of fraction B of the first regeneration effluent. The mixture of effluents obtained advantageously comprises at least one sulphate salt, preferably ammonium sulphate and/or potassium sulphate.

More preferably, all or part (preferably all) of the second effluent 12 is mixed or combined with all or part (preferably all) of the third regeneration effluent 13 (derived from regeneration of the first cationic resin) and with all or part (preferably all) of fraction B of the first regeneration effluent. The mixture of effluents obtained advantageously comprises at least one sulphate salt, preferably ammonium sulphate and/or potassium sulphate.

Advantageously, the mixture of effluents obtained (whether the mixture of the second effluent 12 with fraction B of the first effluent, or the mixture of the second effluent 12, fraction B of the first effluent, and the third effluent 13), undergoes, in full or in part, concentration via evaporation in an evaporation unit 4. A concentrated fraction 14 is then obtained, preferably comprising the at least one sulphate salt. In some embodiments, the concentrated fraction 14 may also comprise at least one dye and/or at least one protein and/or at least one organic acid, when contained in the input stream 6. Advantageously, the concentrated fraction 14 may have a dry matter concentration ranging from 200 to 500 g/L. The concentrated fraction 14 can then be in full or in part subjected to a crystallization step in a crystallization unit 5. Preferably, crystallization is performed by evaporation of the concentrated fraction 14 to reach saturation of the salts contained in the fraction and more particularly and preferably of the at least one sulphate salt. A crystallized fraction 15, preferably comprising the at least one sulphate salt, and a non-crystallized residual fraction 16 are thus obtained. When the input stream 6 comprises at least one organic acid, the non-crystallized fraction 16 preferably comprises the at least one organic acid (it is then called “organic fraction” herein). When the input stream 6 comprises at least one dye and/or at least one protein, the non-crystallized residual fraction 16 may also comprise the at least one dye and/or the at least one protein.

Preferably, the entirety of the mixture is subjected to evaporation, and optionally to crystallization.

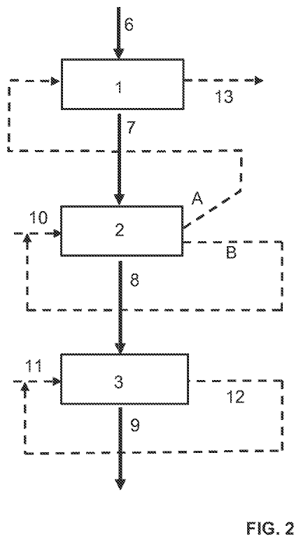

Alternatively, or in addition, the regeneration effluents of the second cation exchange resin and of the anion exchange resin can be used to regenerate these resins as shown in FIG. 2. More particularly, the second regeneration effluent 12 can be wholly or partially used to regenerate the anion exchange resin 3. The second regeneration effluent 12 can be used in addition to another or to other basic regeneration solutions preferably comprising a hydroxide salt, and in particularly preferred manner a solution comprising potassium hydroxide and/or ammonium hydroxide (for example the second regeneration effluent 12 can be used before or after another regeneration solution, or it can be mixed with another regeneration solution before it is passed through the resin). In some embodiments, the second regeneration effluent 12 is the only regeneration solution used to regenerate the anion exchange resin 3, after the initial regeneration. The second regeneration effluent 12 can be used as such, or it can be concentrated or diluted before being used to regenerate the anion exchange resin 3, for example so that the content of potassium hydroxide and/or ammonium hydroxide is 2 to 10% by weight, preferably 4 to 6% by weight.

Fraction B can be wholly or partially used to regenerate the second cation exchange resin 2. Fraction B can be used in addition to another or to other regeneration solutions, preferably a sulphuric acid solution (for example fraction B can be used before or after another regeneration solution, or it can be mixed with another regeneration solution before it is passed through the resin). In some embodiments, fraction B is the only regeneration solution used to regenerate the second cation exchange resin 2, after the initial regeneration. Fraction B can be used as such, or it can be concentrated or diluted before being used to regenerate the second cation exchange resin 2, for example so that the content of sulphuric acid is 1 to 10% by weight, preferably 2 to 10% by weight, more preferably 3 to 9% by weight, for example about 5% by weight.

In some embodiments, part of the second regeneration effluent 12 and part of fraction B can be used to regenerate the anion exchange resin 3 and the second cation exchange resin 2 respectively (as described above); and another part (or the other part) of the second regeneration effluent 12 and another part (or the other part) of fraction B can be combined, optionally with all or part of the third regeneration effluent 13, and can advantageously undergo the treatments described above in connection with the mixture of effluents.

The contacting step of the second fraction 8 with the anion exchange resin 3 (also called “loading of the anion exchange resin”) and the regeneration step of the anion exchange resin 3 can each be independently conducted continuously. Preferably, each of these steps (loading and regeneration) is conducted continuously. In these embodiments, these steps are conducted at least partially simultaneously, each on a column (or on an assembly of several columns in series) connected in parallel or in series with the other column (or assembly of columns) on which the other step is being performed. Preferably, the fluid inlet points and the fluid outlet points of each column of the ion exchange installation are periodically shifted, typically by a column, and preferably simultaneously, after completion of each step.

An example of an ion exchange installation for the anion exchange resin comprises 12 ion exchange columns all comprising a bed of identical anion exchange resin.

Less preferably, the loading and regeneration steps of the anion exchange resin 3 can be performed in batch mode, i.e. they are solely performed in succession, when the preceding step has been completed.

The yield of non-ionised species of the method of the invention, corresponding to the molar percentage of non-ionised species in the input stream 6 recovered in the third fraction 9, is advantageously 90% or higher, preferably 95% or higher, more preferably 97% or higher, further preferably 98% or higher, still further preferably 99% or higher.

Preferably, the rate of salt removal by the method of the invention, corresponding to the molar percentage of salts dissolved in the input stream which is not found in the third fraction, is 50% or higher, preferably 80% or higher, more preferably 85% or higher, further preferably 90% or higher, still further preferably 95% or higher.

The third fraction 9 containing the non-ionised species can be subjected to one or more subsequent treatments such as concentration e.g. via evaporation, demineralization, filtration, treatment on activated carbon.

The concentrated fraction(s) 14 comprising at least one sulphate salt and/or the crystallized fraction(s) 15 comprising at least one sulphate salt can be used to prepare a fertilizer.

The organic fraction(s) can be used to prepare a food, in particular an animal feed.

The invention also concerns a method for producing at least one sulphate salt, comprising the following steps:
providing a mixture of regeneration effluents comprising the at least one sulphate salt;
evaporating the mixture of regeneration effluents to obtain a concentrated fraction comprising the at least one sulphate salt; and
optionally, crystallizing at least part of the concentrated fraction to obtain a crystallized fraction comprising the at least one sulphate salt;
   wherein the providing of the mixture of regeneration effluents comprises the following steps:
supplying a stream comprising monovalent cations, divalent cations and anions;
bringing the stream into contact with a first cation exchange resin in sodium and/or potassium form;
collecting a first fraction enriched in monovalent cations and depleted of divalent cations with respect to the stream;
bringing the first fraction into contact with a second cation exchange resin in hydronium form;
collecting a second fraction depleted of monovalent cations with respect to the first fraction;
regenerating the second cation exchange resin with a sulphuric acid solution;
collecting a regeneration effluent from the second cation exchange resin (called “first regeneration effluent” herein) comprising at least a fraction A, said fraction A comprising sodium and/or potassium ions, and a fraction B, fraction B having a lower concentration of sodium and/or potassium ion than fraction A;
bringing the second fraction into contact with an anion exchange resin;
collecting a third fraction depleted of anions with respect to the second fraction;
regenerating the anion exchange resin with a solution comprising a hydroxide salt, preferably potassium hydroxide and/or ammonium hydroxide;
collecting a regeneration effluent from the anion exchange resin (called “second regeneration effluent” herein);
recycling fraction A of the first regeneration effluent to regenerate the first cation exchange resin;
collecting a regeneration effluent from the first cation exchange resin (called “third regeneration effluent” herein);
mixing the second regeneration effluent, fraction B of the first regeneration effluent and optionally the third regeneration effluent, to obtain a mixture of regeneration effluents.

Preferably, the at least one sulphate salt comprises or consists of ammonium sulphate and/or potassium sulphate.

Advantageously, the stream comprising monovalent cations, divalent cations and anions also comprises a non-ionised species, and the first fraction, the second fraction and the third fraction each contain the non-ionised species; The above description relating to the method for purifying the non-ionised species can apply similarly to the method for producing at least one sulphate salt.

1. A purification method comprising:
supplying a stream comprising a non-ionised species, monovalent cations and divalent cations;
bringing the stream into contact with a first cation exchange resin in sodium and/or potassium form;
collecting a first fraction containing the non-ionised species, enriched in monovalent cations and depleted of divalent cations with respect to the stream;
bringing the first fraction into contact with a second cation exchange resin in hydronium form;
collecting a second fraction containing the non-ionised species, and depleted of monovalent cations with respect to the first fraction;
regenerating the second cation exchange resin with a sulphuric acid solution;
collecting a first regeneration effluent comprising at least one fraction A, said fraction A comprising sodium and/or potassium ions;
recycling fraction A to regenerate the first cation exchange resin.

2. The method according to claim 1, wherein the stream also comprises anions, said method further comprising:
bringing the second fraction into contact with an anion exchange resin;
collecting a third fraction containing the non-ionised species and depleted of anions with respect to the second fraction;
regenerating the anion exchange resin with a solution comprising a hydroxide salt;
collecting a second regeneration effluent.

3. The method according to claim 2, wherein the first regeneration effluent also comprises a fraction B, fraction B having a lower concentration of sodium and/or potassium ions than fraction A of the first effluent, said method further comprising:
mixing at least part of the second effluent with all or part of fraction B of the first effluent, to obtain a mixture of effluents comprising at least one sulphate salt;
evaporating at least part of the mixture of effluents, to obtain a concentrated fraction comprising the at least one sulphate salt; and
optionally a crystallization step of at least part of the concentrated fraction, to obtain a crystallized fraction comprising the at least one sulphate salt.

4. The method according to claim 3, comprising collecting a third regeneration effluent from the first cation exchange resin, and wherein at least part of the second effluent is mixed with all or part of fraction B of the first effluent and with at least part of the third effluent, to obtain the mixture of effluents comprising at least one sulphate salt.

5. The method according to claim 1, wherein the first regeneration effluent also comprises a fraction B, fraction B having a lower concentration of sodium and/or potassium ions than fraction A of the first effluent, said method further comprising a step of recycling at least part of fraction B to regenerate the second cation exchange resin.

6. The method according to claim 2, further comprising a step of recycling at least part of the second regeneration effluent to regenerate the anion exchange resin.

7. The method according to claim 1, wherein the step of bringing the first fraction into contact with the second cation exchange resin is conducted in a multicolumn ion exchange installation.

8. The method according to claim 2, wherein the step of bringing the second fraction into contact with the anion exchange resin is conducted in a multicolumn ion exchange installation.

9. The method according to claim 1, wherein fraction A represents at most 70% by volume of the first regeneration effluent.

10. The method according to claim 1, wherein the sulphuric acid solution has a constant concentration of sulphuric acid.

11. The method according to claim 1, wherein the non-ionised species is selected from the group consisting of polysaccharides, oligosaccharides, monosaccharides, disaccharides, and combinations thereof.

12. The method according to claim 1, wherein the step of bringing the first fraction into contact with the second cation exchange resin and/or the regeneration of the second cation exchange resin is conducted continuously.

13. The method according to claim 2, wherein the step of bringing the second fraction into contact with the anion exchange resin and/or the regeneration of the anion exchange resin is carried out continuously.

14. The method according to claim 1, wherein the first cation exchange resin and the second cation exchange resin have identical matrices.

15. The method according to claim 3, wherein the first regeneration effluent consists of fraction A and fraction B.

16. The method according to claim 1, wherein the stream has a dry matter content of 5 to 50% by weight.

17. The method according to claim 1, wherein the divalent cations comprise calcium ions and/or magnesium ions, and/or the monovalent cations comprise sodium ions and/or potassium ions.

18. The method according to claim 2, wherein the anions comprise chloride ions and/or sulphate ions and/or phosphate ions.

19. The method according to claim 2, wherein the hydroxide salt is potassium hydroxide and/or ammonium hydroxide.

20. The method according to claim 10, wherein the sulphuric acid solution comprises 1 to 10% by weight of sulphuric acid.
